(19) United States
(12) Patent Application Publication
(10) Pub. No.: US 2007/0111879 A1
(43) Pub. Date: May 17, 2007

(54) Zirconia-alumina nano-composite powder and preparation method thereof

(76) Inventor: Young Min Kong, Daejeon-city (KR)

Correspondence Address: MCKENNA LONG & ALDRIDGE LLP, 1900 K STREET, NW, WASHINGTON, DC, 20006, US

(21) Appl. No.: 10/563,247

(22) PCT Filed: Oct. 8, 2005
(86) PCT No.: PCT/KR05/03349

§ 371 Date: Jan. 4, 2006

(30) Foreign Application Priority Data
Oct. 8, 2004 (KR) 10-2004-0080356
Oct. 7, 2005 (KR) 10-2005-0094526

(51) Int. Cl. C04B 35/48; C04B 35/488; C04B 35/64; C04B 35/71

(52) U.S. Cl. 501/105

(57) ABSTRACT

Provided are a multi-component ceramic nano-composite powder that is suitable for forming a sintered ceramic composite and a method of preparing the same. The ceramic nano-composite powder is formed of secondary particles obtained by sintering multi-component ceramic particles with a nano-sized primary particle diameter in nano-scale. The multi-component ceramic particles may be formed of zirconia and alumina. A sintered zirconia-alumina composite formed by sintering the nano-composite powder has greater flexural strength than a sintered composite prepared by mechanically mixing zirconia powder and alumina powder and sintering the mixture.

### BACKGROUND OF THE INVENTION

1. Field of the Invention

The present invention relates to ceramic nano-composite powder formed of secondary particles prepared by sintering different metal oxides, that is, multi-component ceramic primary particles in nano-scale, and a method of preparing the same, and more particularly, to zirconia-alumina nano-composite powder of which flexural strength of the sintered powder compact is excellent and a method of preparing the same.

2. Description of the Related Art

Many efforts have been made to develop sintered alumina-zirconia composites by dispersing ZrO₂ particles in an Al₂O₃ ceramic matrix and to increase the mechanical strength and toughness thereof. However, zirconia, which is added to form a sintered alumina-zirconia composite by mechanically mixing alumina powder and zirconia powder, has a large initial particle size, and the temperature of sintering for densification of the alumina matrix is high. As a result, it is difficult to control the size of zirconia particles that are secondary phase particles and to uniformly disperse zirconia particles in a sintered product. Due to these problems, it is difficult to improve the mechanical properties of such sintered alumina-zirconia composites.

As disclosed in Korean Patent Publication No. 2002-0032642, commercial alumina powder can be added to a zirconium oxychloride aqueous solution and mixed such that 5-20% by volume of zirconia is dispersed. Then, the zirconium oxychloride aqueous solution in which the alumina powder is dispersed is co-precipitated or hydrolyzed to attach zirconium-hydroxide to the surfaces of alumina particles, calcined, and sintered to produce a sintered alumina-zirconia composite. However, the produced sintered alumina-zirconia composite exhibits insufficient mechanical strength and toughness.

Meanwhile, it is known that nano-composites or sintered nano-composites have improved mechanical, physical, and electrical properties, which cannot be obtained from conventional materials regardless of whether the conventional materials are individual components or sintered micro-sized composites. These properties are known to be related to the ultra fine crystallite size of source powder, which is, in general, 100 nm or less and forms grains through sintering.

A basic process for forming a nano-composite or sintered nano-composite is to pulverizing and mixing starting materials. That is, small particles of different components are milled through, such as ball milling, attrition milling, planetary milling, or the like. In addition to mechanically pulverizing through milling, mixing, and homogenizing starting materials, various non-conventional methods of preparing a multi-component mixed powder are disclosed. However, these non-conventional methods require relatively high processing temperatures, evaporative decomposition, and complicate pH controlling. In addition, nano-sized powder particles prepared using these non-conventional methods quickly grow during a subsequent sintering process and thus cannot have excellent nano-properties.

In particular, when a sintered zirconia-alumina composite is produced, it is difficult to attain sufficient densification through only pressureless sintering. That is, while a component undergoes a pressureless sintering process, the transfer of the other component is hindered and thus densification is suppressed. As a result, a higher sintering temperature is required. Therefore, an additional sintering technique, such as hot-isostatic-pressing (HIP), is required after the pressureless sintering process. When the sintering temperature is increased further for easy mass transferring, particles grow and formation of a nano-sized homogeneous microstructure is suppressed. Therefore, there is a need to use a nano-composite powder formed by sintering primary particles in nano-scale in order to suppress the growth of particles during a sintering process and facilitate densification.

### SUMMARY OF THE INVENTION

The present invention provides a zirconia-alumina nano-composite powder that is suitable for forming a sintered composite with excellent mechanical strength.

The present invention also provides a method of preparing the zirconia-alumina nano-composite powder.

According to an aspect of the present invention, there is provided zirconia-alumina nano-composite powder formed of secondary particles prepared by sintering in nano-scale of zirconia having a primary particle diameter of 10-50 nm and alumina having a primary particle diameter of 10-100 nm.

The zirconia-alumina nano-composite powder may further contain an oxide of at least one metal selected from the group consisting of yttrium, magnesium, calcium, cerium, niobium, scandium, neodymium, plutonium, praseodymium, samarium, europium, gadolinium, promethium, and erbium.

In the zirconia-alumina nano-composite powder, a weight ratio of the zirconia to the alumina may be in the range of 99.9:0.1 to 50:50.

According to another aspect of the present invention, there is provided a method of preparing the zirconia-alumina nano composite powder, the method including: mixing a mixed solution of a polyhydric alcohol and a carboxylic acid, and a mixed solution of a zirconium salt and an aluminum salt; heating the resulting mixture at 100-300° C. to produce a polyester network structure where zirconium ions and aluminum ions are captured; and calcinating the result at 400-1000° C.

The polyhydric alcohol may be ethyleneglycol, propyleneglycol, diethyleneglycol, triethyleneglycol, dipropyleneglycol, hexyleneglycol, butyleneglycol, glycerol, hydroquinone (p-dioxybenzene), catechol (1,2-dihydroxybenzene), resorcinol (resorcine or 1,3-dioxybenzene), pyrogallol (1,2,3-trihydroxybenzene), 5-hydroxymethylresorcinol (3,5-dihydroxybenzyl alcohol), phloroglucinol (1,3,5-trihydroxy benzene), or dihydroxybiphenol.

The carboxylic acid may be a citric acid, a benzenetricarboxylic acid, a cyclopentatetracarboxylic acid, an adipic acid (1,4-butanedicarboxylic acid), a maleic acid (1,2-ethylenedicarboxylic acid), an oxalic acid, an succinic acid, a tartaric acid (dioxysuccinic acid), a mesaconic acid (methyl fumaric acid), a glutaric acid (n-pyrrotartaric acid), a malonic acid, a glycolic acid, a malic acid, a lactic cid, a gluconic acid, a fumaric acid, a phthalic acid (o-benzenedicarboxylic acid), an isophthalic acid (m-benzenedicarboxylic acid), a terephthalic acid, an m-hydroxybenzoic acid, a p-hydroxybenzoic acid, a salicylic acid (o-hydroxybenzoic acid), an itacnic acid (methylenesuccinic acid), a citraconic acid, an aconitic acid, a galic acid, a hydroxyethylehtylenediaminetriacetic acid (HEDTA), an ethyleneglycoltetraacetic acid (EGTA), an ethylenediaminetetraacetic acid (EDTA), glutamic acid, an aspartic acid, or an ethylenediaminetetrapionic acid.

Each of the zirconium salt and the aluminum salt may be one of a chloride, a nitrate, and a hydroxide thereof.

The molar ratio of the polyhydric alcohol and the carboxylic acid may be in the range of 10:90 to 90:10.

The mixed solution of a zirconium salt and an aluminum salt may further contain at least one metal salt selected from the group consisting of an yttrium salt, a magnesium salt, a calcium salt, a cerium salt, a cerium salt, a niobium salt, a scandium salt, a neodymium salt, a plutonium salt, a praseodymium salt, a samarium salt, an europium salt, a gadolinium salt, a promethium salt, and an erbium salt.

The weight ratio of the zirconia-alumina nano-composite powder prepared using a zirconium salt and an aluminum salt to the mixed solution of a polyhydric alcohol and a carboxylic acid to may be in the range of 10:1 to 10:999.9.

A sintered zirconia-alumina composite prepared from the zirconia-alumina nano-composite powder has excellent flexural strength and a low sintering temperature.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a polymer network structure where zirconium ions and aluminum ions are captured when a zirconia-alumina nano-composite powder according to an embodiment of the present invention is prepared;

FIG. 2 is TEM images and electron diffraction patterns of co-precipitated powder of zirconia and alumina according to Comparative Example 2, wherein (A) and (B) are respectively TEM images of zirconia and alumina in a mixed powder of secondary zirconia particles and secondary alumina particles formed by aggregating primary zirconia and alumina particles prepared without using a polymer, and (C) and (D) are respectively electron diffraction patterns of zirconia shown in (A) and alumina shown in (B);

FIG. 3 is TEM images of zirconia-alumina nano-composite powder to which a polymer network is added according to an embodiment of the present invention, wherein (A) and (B) are respectively a bright field image and a dark field image of zirconia-alumina nano-composite powder formed by sintering primary particles of zirconia and primary particles of alumina in nano-scale when a great amount of a polymer matrix are added into the mixed solution of zirconium salt and aluminum salt (a weight ratio of the polymer matrix to oxide powder prepared using metal salt solution is 9:1), (C) is a TEM image showing secondary particles of alumina, which are produced in a small amount while zirconia-alumina nano-composite powder is produced, when an amount of polymer matrix addition is reduced (a weight ratio of the polymer matrix to oxide powder prepared using metal salt solution is 1:1), (D) is a TEM image showing powder in which primary particles of zirconia are embedded in secondary particles of alumina when a small amount of a polymer network is added (a weight ratio of the polymer matrix to oxide powder prepared using metal salt solution is 0.1:1);

FIG. 4 is a high-resolution TEM image of zirconia-alumina nano-composite powder according to an embodiment of the present invention;

FIG. 5 illustrates an XRD pattern of zironia—alumina nano-composite powder calcined at 800° C.;

FIG. 6 illustrates flexural strengths of sintered zirconia-alumina composites prepared according to Example 1 and Comparative Examples 1 and 2;

FIG. 7 is SEM images of zirconia-alumina composite sintered at 1300° C., wherein (A) shows a microstructure of a sintered product of nano-composite powder prepared using a large amount of polymer (a weight ratio of the polymer matrix to oxide powder prepared using metal salt solution is 9:1), (B) shows a microstructure of a sintered product of a nano-composite powder prepared using a polymer (a weight ratio of the polymer matrix to oxide powder prepared using metal salt solution is 1:1), and (C) shows a microstructure of a sintered product of co-precipitated powder to which a polymer is not added; and

FIG. 8 is SEM images of composites sintered at 1400° C., wherein (A) shows a microstructure of a sintered product of nano-composite powder prepared using a large amount of polymer (a weight ratio of the polymer matrix to oxide powder prepared using metal salt solution is 9:1), (B) shows a microstructure of a sintered product of nano-composite powder prepared using a small amount of polymer (a weight ratio of the polymer matrix to oxide powder prepared using metal salt solution is 0.1:1), and (C) shows a microstructure of a sintered product of co-precipitated powder to which a polymer is not added, and (D) shows a microstructure of sintered powder compact formed by mixing commercial zirconia powder and alumina powder and sintering the mixed powder.

### DETAILED DESCRIPTION OF THE INVENTION

In the present specification, the term “nano-composite powder” refers to a composite powder formed of secondary particles prepared by sintering primary particles of at least two kinds of nano-sized metal oxides in nano-scales.

That is, nano-composite powder refers to powder formed by homogeneously dispersing and capturing a desired metal ion in a polyester network structure playing an important role when preparing nano-sized primary particles on an atomic level, and then oxidizing the captured metal ion through a heat treatment (calcination) and at the same time sintering primary particles which are locally captured, using a high oxidation reaction heat of the polymer network structure (to obtain secondary particles that are composites of the primary nano-sized particles of at least two kinds of metal oxides).

The present invention provides zirconia-alumina nano-composite powder formed of secondary particles prepared by sintering in nano-scale of zirconia having a primary particle diameter of 10-50 nm and alumina having a primary particle diameter of 10-100 nm.

Since the zirconia-alumina nano-composite powder according to an embodiment of the present invention is formed of secondary particles prepared by sintering nano-sized primary particles of zirconia and alumina that are microscopically homogeneously mixed, some zirconia particles are covered by alumina particles while some zirconia particles are partially embedded into and partially exposed to the surfaces of alumina particles. That is, the nano-composite powder is formed of secondary particles that are composites formed by sintering nano-sized primary particles of components. Therefore, when trying to pick up a single-component particle using a nano tweezer, always a mixed-component particle is picked up. Accordingly, it is difficult to physically separate the different components in individual particles. On the other hand, ceramic nano-powder or composite, so-called nano-composite, prepared using conventional methods is a cluster of nano-sized primary particles of different kinds of ceramics, that is, co-precipitated powder in which secondary particles of different ceramics are homogeneously mixed, or powder in which the surface of a kind of ceramic powder is coated with another kind of ceramic powder. In this case, desired ceramic component powder can be easily separated from the composite powder using a nano tweezer.

The nano-composite powder according to the present invention may further contain an oxide of at least one metal selected from the group consisting of yttrium, magnesium, calcium, cerium, niobium, scandium, neodymium, plutonium, praseodymium, samarium, europium, gadolinium, promethium, and erbium. The metal oxide included in zirconia improves physical properties of zirconia. The molar ratio of the metal oxide to zirconia may be in the range of 0.0001:1-20:1. In the nano-composite powder, a weight ratio of zirconia particles to alumina particles may be in the range of 99.9:0.1 to 50:50. When the weight ratio does not lie within the above range and the amount of alumina particles is too small, an increase of fracture toughness is small. On the other hand, when the amount of alumina particles is too large, an increase of strength is small.

The zirconia-alumina nano-composite powder according to an embodiment of the present invention is featured in that it is prepared using a polymer network structure.

Zirconia-alumina nano-composite powder according to an embodiment of the present invention is formed using a method including mixing a mixed solution of a polyhydric alcohol and a carboxylic acid, and a mixed solution of a zirconium salt and an aluminum salt; heating the resulting mixed solution at 100-300° C. to form a polyester network structure where zirconium ions and aluminum ions are captured; and calcinating the resulting structure at 400-1000° C.

The mixed solution of a polyhydric alcohol and a carboxylic acid form polyester in a network structure in the presence of a zirconium salt and an aluminum salt.

Zirconium ions and aluminum ions are electrostatically captured in each cell of the polyester network structure.

Examples of the polyhydric alcohol may include ethyleneglycol, propyleneglycol, diethyleneglycol, triethyleneglycol, dipropyleneglycol, hexyleneglycol, butyleneglycol, glycerol, hydroquinone (p-dioxybenzene), catechol (1,2-dihydroxybenzene), resorcinol (resorcine or 1,3-dioxybenzene), pyrogallol (1,2,3-trihydroxybenzene), 5-hydroxymethylresorcinol (3,5-dihydroxybenzyl alcohol), phlorgucinol (1,3,5-trihydroxy benzene), dihydroxybiphenol, wherein ethyleneglycol is preferred. Examples of the carboxylic acid may include a citric acid, a benzenetricarboxylic acid, a cyclopentatetracarboxylic acid, an adipic acid (1,4-butanedicarboxylic acid), a maleic acid (1,2-ethylenedicarboxylic acid), an oxalic acid, an succinic acid, a tartaric acid (dioxysuccinic acid), a mesaconic acid (methyl fumaric acid), a glutaric acid (n-pyrrotartaric acid), a malonic acid, a glycolic acid, a malic acid, a lactic cid, a gluconic acid, a fumaric acid, a phthalic acid (o-benzenedicarboxylic acid), an isophthalic acid (m-benzenedicarboxylic acid), a terephthalic acid, an m-hydroxybenzoic acid, a p-hydroxybenzoic acid, a salicylic acid (o-hydroxybenzoic acid), an itacnic acid (methylenesuccinic acid), a citraconic acid, an aconitic acid, a galic acid, a hydroxyethylehtylenediaminetriacetic acid (HEDTA), an ethyleneglycoltetraacetic acid (EGTA), an ethylenediaminetetraacetic acid (EDTA), glutamic acid, an aspartic acid, and an ethylenediaminetetrapionic acid, wherein citric acid is preferred.

The molar ratio of the polyhydric alcohol and the carboxylic acid may be in the range of 10:90 to 90:10. When the molar ratio does not lie within this range, a polyester network structure capable of capturing metal ions becomes sparse, and the sizes of unit cells increase. Accordingly, portions where nano-composite powder can be made are substantially reduced and thus the yield of the nano-composite powder decreases.

Each of the zirconium salt and the aluminum salt may be a chloride, nitrate, or hydroxide thereof.

The weight ratio of the mixed solution of a polyhydric alcohol and a carboxylic acid to the zirconia-alumina nano-composite powder prepared from a zirconium salt and an aluminum salt may be in the range of 1:10 to 999.9:10. When the weight ratio of the mixed solution to the zirconia-alumina nano-composite powder does not lie within the above range, the yield of the zirconia-alumina nano-composite powder may decrease.

The mixed solution of a zirconium salt and an aluminum salt may further contain at least one metal salt selected from the group consisting of an yttrium salt, a magnesium salt, a calcium salt, a cerium salt, a niobium salt, a scandium salt, a neodymium salt, a plutonium salt, a praseodymium salt, a samarium salt, an europium salt, a gadolinium salt, a promethium salt, and an erbium salt. Metal elements included in zirconia improve physical properties of zirconia. The molar ratio of such a metal salt in oxide form to zirconia may be in the range of 0.0001:1-20:1. Like glass constructed of a network former and a network modifier, the polyester network structure where metal ions are captured is constructed of a polymer network former and a metal cationic network modifier. Metal ions as a network modifier are homogeneously distributed in an atomic size throughout a polyester network. In general, such a structure does not require a wide range of dispersion during a subsequent process of forming a metal oxide, and allows a precise stoichiometric, homogeneous single-phase metal oxide to be formed at a relatively low temperature.

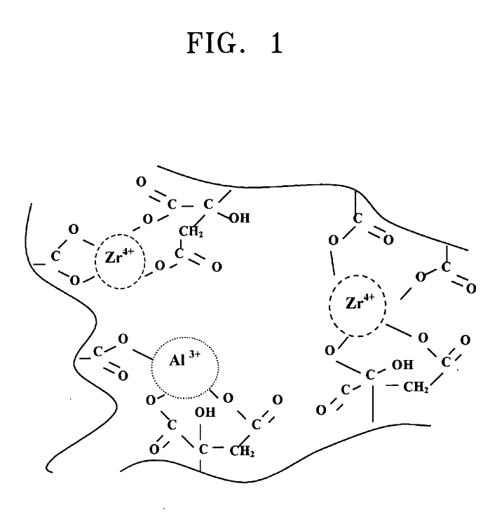

In order to prepare zirconia-alumina nano-composite powder according to the present invention, zirconium and aluminum are added as metallic ions to a polyester network. Zirconium ions and aluminum ions are distributed in the polyester network as schematically illustrated in FIG. 1, and oxidized in a subsequent heat treatment process to produce primary particles of zirconia and alumina. Then, these nano-particles are sintered through a following heat treatment to produce secondary particles forming nano-composite powder. Since zirconia and alumina do not make solid-solution, there is no potential of forming a single compound. Therefore, when zirconium ions contact aluminum ions in the polymer network, nano-sized composite powder can be produced in a subsequent heat treatment process. Unlike the present invention, when no polymer is added to a metallic ion solution, particles of a zirconium salt and particles of an aluminum salt separately precipitate in a heat treatment process of a metal salt solution, and the precipitated metal salts are oxidized in a subsequent calcination process to produce zirconia and alumina powder, which is a mixture of zirconia and alumina powder in micron. While the particle size of zirconia is in the range of 100-200 nm, the particle size of alumina is 500 nm or greater because alumina particles are more aggregated. The zirconia particles are tetragonal phase particles, and the alumina particles are highly-agglomerated clusters of primary particles. As a result, microscopically homogeneously mixed nano-composite powder as in the present invention cannot be produced.

When a polymer precursor, that is, a mixed solution of a carboxylic acid and a polyhydric alcohol, is added as in the present invention, zirconia-alumina nano-composite powder can be formed. Individual particles begin to form zirconia-alumina nano-composite powder, and agglomerates of alumina and zirconia particles become smaller. All the secondary particles are clusters having a diameter of 100-200 nm. The zirconia-alumina nano-composite powder contains nano-crystalline zirconia having a diameter of about 10-50 nm. When a polymer is added to a metal source (a solution of metal salt), metal ions are captured in carboxyl groups dissociated in the polymer matrix while the metal ions are homogeneously distributed close to each other. The resultant polymer matrix where zirconium ions and aluminum ions are captured is calcined at 400 to 1000° C. to remove the polymer and obtain nano-composite powder. That is, aluminum ions and zirconium ions are uniformly dispersed and mixed in a polymer matrix structure on a molecular level, and many zirconium ions act as growth nuclei of zirconia in subsequent processes. The zirconia initially grow into nano-sized particles and homogeneously dispersed and mixed with aluminum, which is oxidized at a relatively high temperature, on a molecular level to produce sintered composite powder of zirconia nano-particles and alumina nano-particles.

The nano-composite powder prepared as described above is hot pressed to produce a sintered composite having an increased sintering density and flexural strength.

While HIP (hot isostatic pressing) is performed at a high temperature of 1600° C. or higher, the hot pressing, which is used to prepare a zirconia-alumina sintered composite, can be performed at a relatively low temperature of 1300-1500° C. when the nano-composite powder according to the present invention is used.

The microstructure of the hot-pressed specimens with nano-composite powder is very fine and homogeneous, compared with the microstructure of a micro composite.

The nano-composite powder is effective to increase the sinterability and mechanical strength of a sintered composite body. The flexural strength of a sintered composite formed by hot-pressing nano-composite powder is 1.5 times greater than the flexural strength of a sintered composite prepared using powder formed by mechanically mixing zirconia and alumina and the flexural strength of a micro-sized sintered composite prepared using a co-precipitated powder of zirconia and alumina without a polymer network.

The nano-composite powder according to the present invention can be widely used in various fields, such as bioceramics, catalysts, and electronic ceramics.

The present invention will be described in further detail with reference to the following examples. The following examples are for illustrative purposes only and are not intended to limit the scope of the present invention.

### EXAMPLES

### Example 1

A metal chloride was used as a cation source, and citric acid monohydrate (CAM, C₆H₈O₇·H₂O) and ethylene glycol (EG, C₂H₆O₂) were used for a polymer network.

AlCl₃·6H₂O, ZrCl₂O·8H₂O, YCl₃·6H₂O (obtained from Aldrich Chemical Co. Inc., Milwaukee, Wis., USA), CAM, and EG were used as starting materials. These starting materials except for YCl₃·6H₂O were purchased from Kanto Chemical Co. Inc., Tokyo, Japan.

A stoichiometric mixture of Zr and Y source solutions (ZrO₂ doped with 3 mol % of Y₂O₃) and an Al source solution were used as starting materials. A polymer network was constructed of CAM and EG in a mole ratio of 33:67, the total amount of the added polymer was 900 parts by weight based on 100 parts by weight of the metal oxide, and a weight ratio of zirconia to alumina was 1:0.25.

The metal source was mixed with the CAM-EG solution and the resulting mixture solution was heated at 130° C. to facilitate esterification between CAM and EG. As the mixture solution concentrated, the viscosity of the solution increased and the color thereof was changed from colorless to yellow and then brown. The resulting gel was dried, pulverized, and calcined at a temperature of 200-1000° C. The calcined powder was analyzed using an X-ray diffraction analyzer (M18XHF, Mac Science, Yokohama, Japan). In addition, the calcined powder was observed using a TEM to identify the formation of nano-composite powder.

The calcined powder was ball-milled in ethanol using a ZrO₂ ball for 48 hours to reduce the size of secondary particles. The powder was sintered by hot-pressing using a graphite die at 1300-1500° C. and 30 MPa in an Ar atmosphere for 1 hour. Here, the temperature was increased by 10° C./min, and cooling was performed in a furnace.

The phase of the hot-pressed body was analyzed using an X-ray diffraction analyzer, and the density was measured according to Archimedes' method. In order to observe the microstructure of the hot-pressed body, the hot-pressed body was subjected to surface mirror processing using a 1-micron diamond slurry and measured using a SEM (JSM-6330F, JEOL, Tokyo, Japan). The flexural strength was measured by a 4-point flexural strength test. The flexural strengths of seven samples were measured.

### Example 2

Powder was synthesized and a sintered body thereof was prepared in the same manner as in Example 1, except that the total amount of the added polymer was 100 parts by weight based on 100 parts by weight of the metal oxide.

### Example 3

Powder was synthesized and a sintered body thereof was prepared in the same manner as in Example 1, except that the total amount of the added polymer was 10 parts by weight based on 100 parts by weight of the metal oxide.

### Example 4

Powder was synthesized and a sintered body thereof was prepared in the same manner as in Example 1, except that 5 mol % yttria and 4 mol % nyobia were doped in zirconia.

### Example 5

Powder was synthesized and a sintered body thereof was prepared in the same manner as in Example 1, except that the ratio of zirconia particles to alumina particles was 90:10.

### Example 6

Powder was synthesized and a sintered body thereof was prepared in the same manner as in Example 1, except that the ratio of zirconia particles to alumina particles was 70:30.

### Example 7

Powder was synthesized and a sintered body thereof was prepared in the same manner as in Example 1, except that the ratio of zirconia particles to alumina particles was 50:50.

### Comparative Example 1

Commercially available zirconia powder (TZ-3Y, Tosoh, Japan) and alumina powder (AKP 50, Sumitomo, Japan) were ball-milled to produce mixed powder of zirconia and alumina. The resulting mixed powder compact was sintered by hot pressing under the same conditions as in Example 1 to produce a composite. The flexural strength of the composite was measured.

### Comparative Example 2

Powder was prepared in the same manner as in Example 1 using the metal chloride as a cation source, except that CAM and EG were not added.

The powder was analyzed using a TEM and an X-ray diffraction analyzer as described in Example 1. The powder compact was sintered by hot pressing under the same conditions as in Example 1 to produce a composite sintered product, and the flexural strength of the sintered composite was measured.

TABLE 1

| Example | Flexural Strength (MPa) |
|---|---|
| Example 1 | 1450 |
| Example 2 | 1330 |
| Example 3 | 1230 |
| Example 4 | 1050 |
| Example 5 | 1300 |
| Example 6 | 1370 |
| Example 7 | 1200 |
| Comparative Example 1 | 980 |
| Comparative Example 2 | 830 |

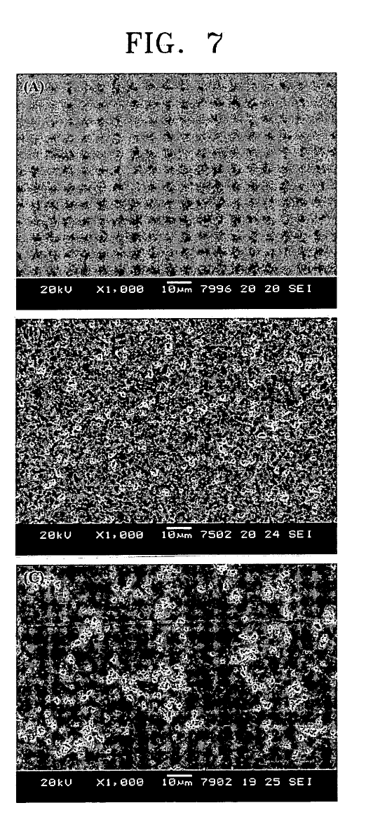

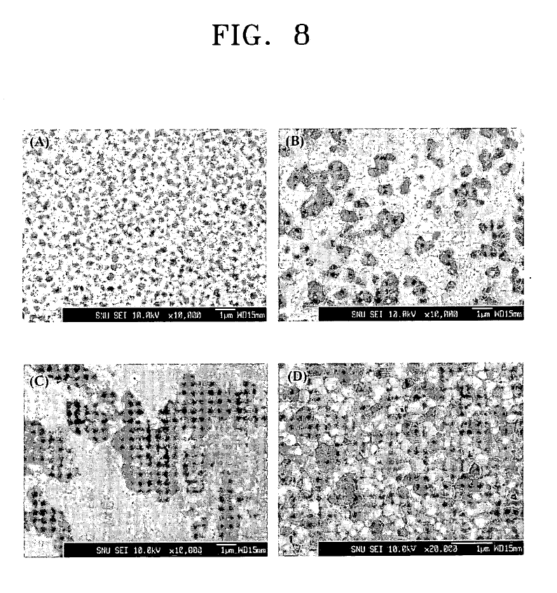

While the zirconia-alumina nano-composites prepared according to Examples 1 through 7 have sufficiently high densities at a relatively low temperature (1300° C.), the composites prepared according to Comparative Examples 1 and 2 have low densities. As shown in (A) of FIG. 7, when the zirconia-alumina nano-composite powder according to Example 1 is sintered, micropores are not formed and a microstructure where very small zirconia and alumina particles are homogeneously distributed is obtained. Referring to (B) in FIG. 7, when the nano-composite powder according to Example 2 is sintered, a few micropores are formed and a microstructure where darker alumina particles are uniformly distributed in a brighter zirconia matrix phase is obtained. However, when the co-precipitated powder of zirconia and alumina according to Comparative Example 2 is sintered, dark alumina particles are non-uniformly distributed in a zirconia matrix phase and a sintered body having micropores is formed [FIG. 7(C)]. As shown in Table 1 and FIG. 6, the maximum flexural strength, which is a 4-point flexural strength value, of the sintered body prepared using the zirconia-alumina nano-composite powder according to Example 1 is 1450 MPa, which is greater than 980 MPa of Comparative Example 1 and 830 MPa of Comparative Example 2, and is comparable with a 3-point flexural strength value of about 2,000 MPa of a composite prepared through HIP. The greater flexural strengths of the composites according to the present invention are supported by microstructures shown in FIG. 8.

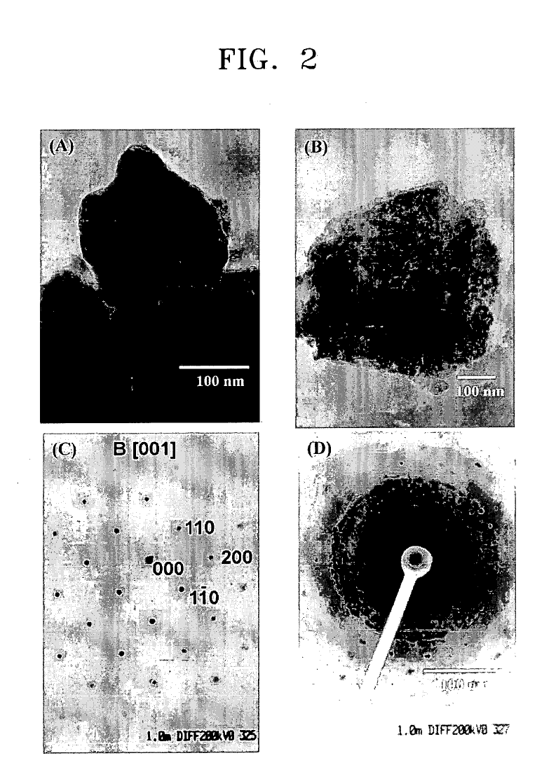

FIG. 2 is TEM images of the co-precipitated powder of zirconia and alumina prepared according to Comparative Example 2. The co-precipitated powder of zirconia and alumina prepared without adding a polymer to the metallic ion solution consists of secondary particles obtained as a result of agglomerating separately formed nano-primary particles of zirconia and alumina in a subsequent process. The co-precipitated powder is formed of a mixture of micron-sized zirconia (A) and alumina (B) particles as shown in (A) and (B) of FIG. 2. Zirconia particles with a particle size of 100-200 nm is in a tetragonal crystalline phase as shown in the electron diffraction pattern of (C) of FIG. 2. Alumina particles form agglomerates (about 500 nm) of primary particles oriented in various crystalline directions as shown in the electron diffraction pattern in (D) of FIG. 2. Meanwhile, in the powder (Comparative Example 1) obtained by mechanically mixing commercially available zirconia powder and alumina powder, secondary particles with a particle size of 300 nm exist.

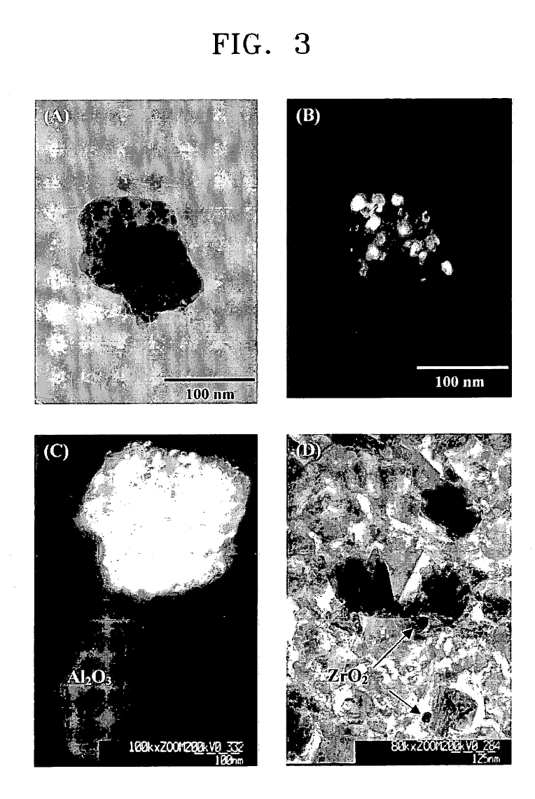

FIG. 3 is TEM images of the zirconia-alumina nano-composite powders prepared according to Examples 1, 2, and 3. In Example 1 where a large amount of polymer was added, zirconia-alumina nano-composite powder is produced as shown in (A) and (B) of FIG. 3. (A) of FIG. 3 is a bright field image of the zirconia-alumina nano-composite powder according to Example 1. (B) of FIG. 3 is a dark field image of the zirconia-alumina nano-composite powder according to Example 1, where white circular particles are zirconia crystallite having a size of about 10 nm. When the amount of the polymer matrix is reduced as in Example 2, a small amount of alumina secondary particles, in addition to the zirconia-alumina nano-composite powder, appear as shown in (C) of FIG. 3. When the amount of the polymer network is further reduced as in Example 3, a small amount of the zirconia-alumina nano-composite powder and an agglomerated zirconia/alumina powder (where zirconia primary particles were embedded in alumina secondary particles as shown in (D) of FIG. 3) are formed.

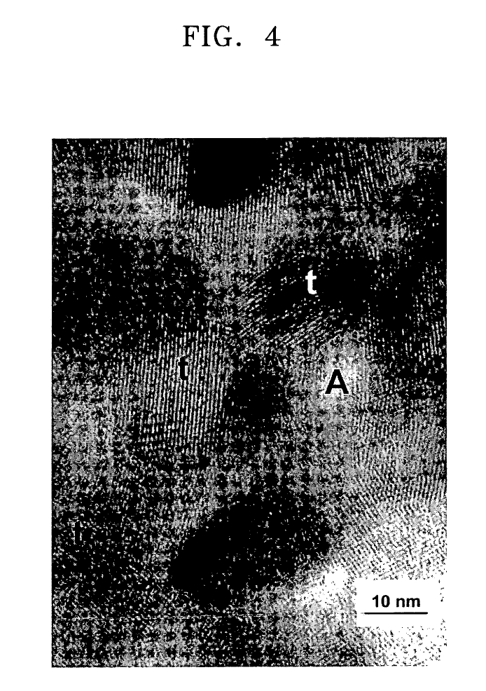

Zirconia-alumina nano-composite powder according to an embodiment of the present invention contains nano-crystalline zirconia having a diameter of about 10 nm, as indicated by “t” in dark portions in a high resolution TEM image of FIG. 4. This result matches the result of (B) of FIG. 3.

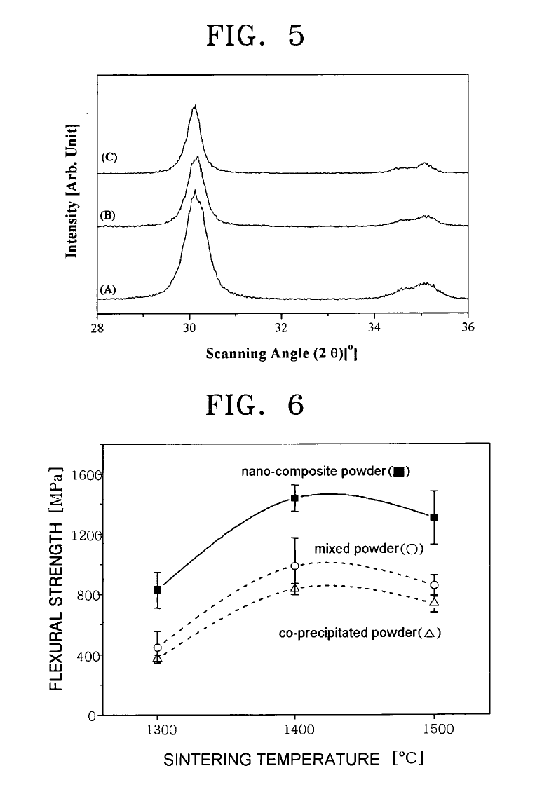

FIG. 5 shows XRD patterns of zirconia-alumina nano-composite powder prepared according Examples 1 and 3 and Comparative Example 2. Referring to FIG. 5, when a polymer network is used and when a larger amount of polymer network is used, the full width at half maximum of a main diffraction peak of zirconia in powder is increased, and the size of zirconia particles is reduced. In FIGS. 5, A, B, and C respectively indicate XRD patterns according to Examples 1 and 3 and Comparative Example 2. The result in FIG. 5 indicates that a polymer network is an important factor in preparing zirconia-alumina nano-composite powder.

A hot-pressed composite prepared using zirconia-alumina nano-composite powder according to the present invention has greater flexural strength than a sintered composite prepared using conventionally mixed powder of zirconia and alumina.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A zirconia-alumina nano-composite powder formed of secondary particles prepared by sintering in nano-scale of zirconia having a primary particle diameter of 10-50 nm and alumina having a primary particle diameter of 10-100 nm.

2. The zirconia-alumina nano-composite powder of claim 1, wherein a weight ratio of the zirconia to the alumina is in the range of 99.9:0.1 to 50:50.

3. The zirconia-alumina nano-composite powder of claim 1, further containing an oxide of at least one metal selected from the group consisting of yttrium, magnesium, calcium, cerium, niobium, scandium, neodymium, plutonium, praseodymium, samarium, europium, gadolinium, promethium, and erbium.

4. The zirconia-alumina nano-composite powder of claim 3, wherein the molar ratio of the oxide of at least one metal to the zirconia is in the range of 0.0001:1 to 20:1.

5. A method of preparing the zirconia-alumina nano composite powder of claim 1, the method comprising:
mixing a mixed solution of a polyhydric alcohol and a carboxylic acid and a mixed solution of a zirconium salt and an aluminum salt;
heating the resulting mixture at 100-300° C. to produce a polyester network structure where zirconium ions and aluminum ions are captured; and
calcining the resuling polymer network structure at 400-1000° C.

6. The method of claim 5, wherein the polyhydric alcohol is selected from the group consisting of ethyleneglycol, propyleneglycol, diethyleneglycol, triethyleneglycol, dipropyleneglycol, hexyleneglycol, butyleneglycol, glycerol, hydroquinone (p-dioxybenzene), catechol (1,2-dihydroxybenzene), resorcinol (resorcine or 1,3-dioxybenzene), pyrogallol (1,2,3-trihydroxybenzene), 5-hydroxymethylresorcinol (3,5-dihydroxybenzyl alcohol), phloroglucinol (1,3,5-trihydroxy benzene), and dihydroxybiphenol.

7. The method of claim 5, wherein the carboxylic acid is selected from the group consisting of a citric acid, a benzenetricarboxylic acid, a cyclopentatetracarboxylic acid, an adipic acid (1,4-butanedicarboxylic acid), a maleic acid (1,2-ethylenedicarboxylic acid), an oxalic acid, an succinic acid, a tartaric acid (dioxysuccinic acid), a mesaconic acid (methyl fumaric acid), a glutaric acid (n-pyrrotartaric acid), a malonic acid, a glycolic acid, a malic acid, a lactic cid, a gluconic acid, a fumaric acid, a phthalic acid (o-benzenedicarboxylic acid), an isophthalic acid (m-benzenedicarboxylic acid), a terephthalic acid, an m-hydroxybenzoic acid, a p-hydroxybenzoic acid, a salicylic acid (o-hydroxybenzoic acid), an itacnic acid (methylenesuccinic acid), a citraconic acid, an aconitic acid, a galic acid, a hydroxyethylehtylenediaminetriacetic acid (HEDTA), an ethyleneglycoltetraacetic acid (EGTA), an ethylenediaminetetraacetic acid (EDTA), glutamic acid, an aspartic acid, and an ethylenediaminetetrapionic acid.

8. The method of claim 5, wherein each of the zirconium salt and the aluminum salt is one of a chloride, a nitrate, and a hydroxide thereof.

9. The method of claim 5, wherein the mole ratio of the polyhydric alcohol and the carboxylic acid is in the range of 10:90 to 90:10.

10. The method of claim 5, wherein the mixed solution of a zirconium salt and an aluminum salt further comprises at least one metal salt selected from the group consisting of an yttrium salt, a magnesium salt, a calcium salt, a cerium salt, a cerium salt, a niobium salt, a scandium salt, a neodymium salt, a plutonium salt, a praseodymium salt, a samarium salt, an europium salt, a gadolinium salt, a promethium salt, and an erbium salt.

11. The method of claim 5, wherein the weight ratio of the zirconia-alumina nano-composite powder prepared using a zirconium salt and an aluminum salt to the mixed solution of a polyhydric alcohol and a carboxylic acid is in the range of 10:1 to 10:999.9.

12. A sintered zirconia-alumina composite obtained by sintering the zirconia-alumina nano-composite powder of any one of claims 1 through 4 at 1300 to 1500° C.
